(19) United States
(12) Patent Application Publication
(10) Pub. No.: US 2014/0254135 A1
(43) Pub. Date: Sep. 11, 2014

(54) LIGHT-EMITTING DIODE LIGHT AND HEAT DEVICE

(71) Applicant: SHAT-R-SHIELD, INC., Salisbury, NC (US)

(72) Inventors: Robert J. Nolan, Salisbury, NC (US); Don Cattoni, Huntersville, NC (US); George Charles Mabin, Concord, NC (US)

(73) Assignee: SHAT-R-SHIELD, INC., Salisbury, NC (US)

(21) Appl. No.: 13/791,425

(22) Filed: Mar. 8, 2013

(51) Int. Cl. F21V 29/00

(52) U.S. Cl. CPC F21V 29/008
USPC 362/92; 29/428; 29/527.2

(57) ABSTRACT

A heat and light emitting device comprising a housing and having an air circulation device, a light-emitting diode, and a heating element contained within the housing. The device further comprising a cover for attachment to the housing. The heat and light emitting device is in a form of a heat lamp or in a form of an oval, square, rectangle or other geometric shape. A surface of the device or a component thereof are optionally coated with a coating composition.

### FIELD OF THE INVENTION

The present invention relates to a device for emitting light and heat, particularly a device for emitting light and heat comprising a light-emitting diode (LED).

### BACKGROUND OF THE INVENTION

There are currently a variety of different styles and heating methods for conventional heat lamps. The vast majority of commercial processes use infrared red or clear heat lamps with wattages that typically range between 125 watts and 375 watts to generate an amount of heat that is specified pursuant to government regulation. Additionally, since conventional heat lamps typically comprise glass, there is always the danger when such lamps are used that broken glass will contaminate the product such as food that is being kept warm. Furthermore, existing conventional heat lamps are extremely inefficient and use significant amounts of energy to keep the specified product at a temperature that is safe for human consumption.

Conventional heat lamps are constructed similarly to an incandescent bulb. They have either a metal or ceramic screw socket base and a glass envelope or bulb. The glass bulb is normally epoxy glued into the metal socket base. Many conventional heat lamps include a red filter to minimize the amount of visible light emitted. Conventional heat lamps often include an internal reflector. Conventional heat lamps can generate a lot of excess heat especially if they are operated in the base up position. This excess heat around the base can cause the epoxy glue to fail and cause the glass bulb to separate from the socket base. The conventional heat lamp is also constructed with pressurized gas which can shatter the glass if broken. The conventional heat lamp contains a tungsten element that produces heat and light. Furthermore, such lamps last approximately 5000 hours. It is important to prevent water, moisture, liquids or metal objects from coming in contact with a conventional heat lamp due to possible breakage and shattering of the lamp. These lamps should not be used in wet or moist environments. For these types of applications, special heat-resistant-glass infrared lamps are more appropriate. They are constructed of a heavier glass bulb. This style of lamp is still susceptible of the glass bulb separating from the base and the glass shattering in the event of breakage. There are a variety of different types of commercially available heating elements used for the food, health and brooding industries. Some of the units are thermostatically controlled heating stations and do not have a replaceable heating element and offer incandescent lighting options.

Thus, there is a need for a much safer and energy efficient lighting and heating device. The device of the present invention addresses these needs and overcomes these known disadvantages.

### SUMMARY OF THE INVENTION

The present invention is directed to a device that emits light and heat and comprises a light-emitting diode or diodes (LED) and a heating element. The present invention is also directed to a method of making such a device. The device of the present invention provides improved safety protection to the consumer and much improved energy consumption in industries where heat lamps are used.

In one aspect of the present invention, the heat and light emitting device is in a form of a heat lamp. The heat and light emitting device comprises a base, a housing for attachment to the base, and a cover for attachment to the housing. The housing comprises an air circulation device, a light-emitting diode, and a heating element.

In another aspect of the present invention, the heat and light emitting device is in a form that is suitable to fit a square shaped, rectangular shaped, or other geometric shaped housing. The heat and light emitting device comprises a housing and a cover for attachment to the housing. The housing comprises a light-emitting diode, a heating element, an air circulation device, and an electronic driver for regulating power to the air circulation device and the light-emitting diode. The light-emitting diode is on a printed circuit board having one or more edges.

Among the features of the light and heat emitting device of the present invention is that it is inclusive of a light-emitting diode (LED) light element and a heating element that fit within a housing, and the device is shaped in various configurations including, but not limited to, those similar to existing BR40 glass heat lamp bulbs. In one aspect of the present invention, the device of the present invention is suitable to be a long life, energy efficient direct retrofit for a BR40 heat lamp. In another aspect of the present invention, the device is in a square shape, rectangular shape, or other geometric shape such that it is suitable to be used in modules, and the modules are assembled in order to achieve a desired amount of required heat or light.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, which are not necessarily to scale, wherein:

FIG. 1 is a perspective view of a light and heat emitting device in a form of a heat lamp in accordance with an aspect of the present invention.

FIG. 2 is an exploded view of the device of FIG. 1.

FIG. 3 is a cross-sectional view of the device of FIG. 1.

FIG. 4A is a perspective view of a light and heat emitting device in accordance with an aspect of the present invention in a form of a module(s).

FIG. 4B is an exploded view of the device of FIG. 4A.

FIG. 4C is a close-up view of certain components of the device of FIG. 1 assembled in multiples.

FIG. 4D is a cross-sectional view of the device of FIG. 4A.

### DETAILED DESCRIPTION OF THE INVENTION

The following detailed description of the embodiment(s) is merely exemplary in nature and is in no way intended to limit the invention, its application, or uses.

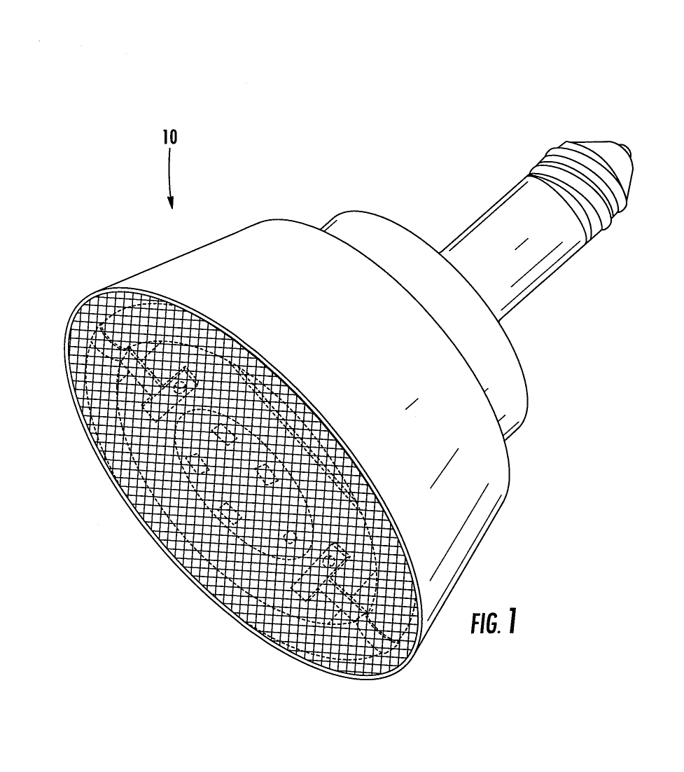

Referring to the figures, FIG. 1 is a perspective view of a light and heat emitting device in a form of a heat lamp 10 in accordance with aspects of the present invention. The heat lamp 10 has one or more external surfaces and one or more internal surfaces. The heat lamp 10 does not contain any toxic materials that could, for example, contaminate a food product to be heated in the event of accidental breakage of the heat lamp. Furthermore, the heat lamp 10 as illustrated in FIG. 1 is energy saving and is suitable as a replacement for a 125 to 375 Watt heat lamp. The device in a form as shown in FIG. 1 has up to 50% energy savings by directing all of the heat in a downward direction. Conventional heat lamps use 250 Watts of energy and lose heat because of natural air and heat movements toward an upright direction especially when the lamp is in a base up position. The device of the present invention, in a configuration as shown in FIG. 1, uses approximately 125 Watts for the same amount of heat yet offers more light.

As shown in FIG. 1, the heat lamp 10 of the present invention preferably has a basic shape and size of a conventional BR40 heat lamp. The advantage of the heat lamp of the present invention having the shape and size of a BR40 heat lamp is that it allows for an immediate retrofit solution to existing inefficient conventional glass heat lamps. However, the heat lamp of the present invention is not limited to this shape and size. It is within the scope of the present invention that the heat lamp is in the form of any number of shapes including, but not limited to, rectangular, oval, square, and other geometric shapes. However, an advantage of the heat lamp of the present invention is that it provides for a safer work environment since it eliminates the possibility of broken glass contaminating the heated product as seen in conventional BR40 heat lamps. Another significant advantage of the heat lamp 10 is that the possibility of the glass separating from the base of existing heat lamps is eliminated. The materials of which heat lamp 10 is constructed preferably comprise metal, ceramic, and polymeric materials, among others.

Additionally, the product life of the heat lamp 10 as shown in FIG. 1 is up to six times longer than a conventional heat lamp because the tungsten heating filament of the conventional heat lamp is eliminated and heat lamp 10 thus provides sustainability due to its longer operating life.

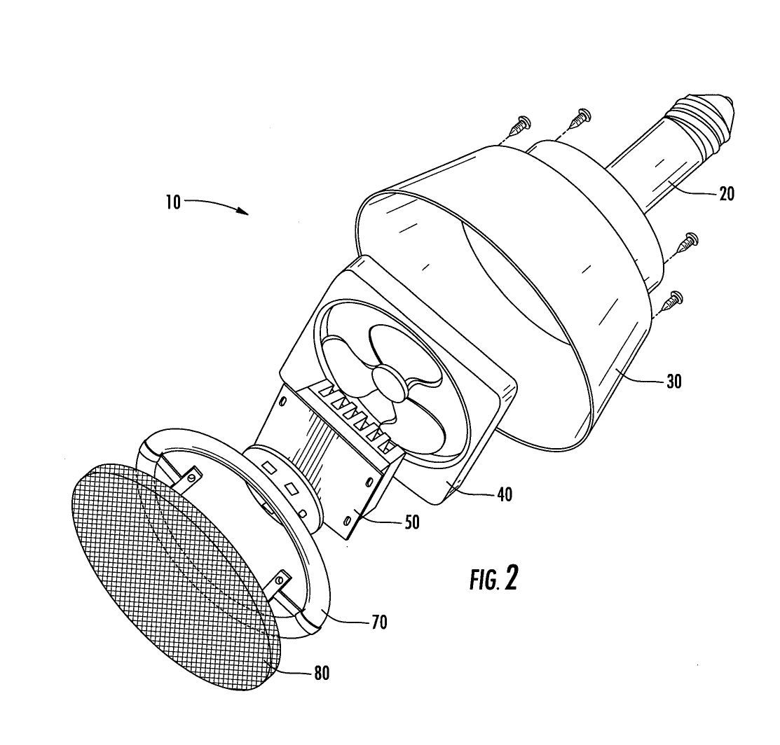

FIG. 2 is an exploded view of the heat lamp 10 of FIG. 1. As shown in FIG. 2, the heat lamp 10 comprises a base 20, a housing 30, an air circulation device 40 such as a fan or piezo type air movement device, a light-emitting diode (LED) driver with electronics 50 to regulate the power current for the LEDs and the heating source, a LED printed circuit board with LED 60, a heating element 70, and a safety screen or cover 80.

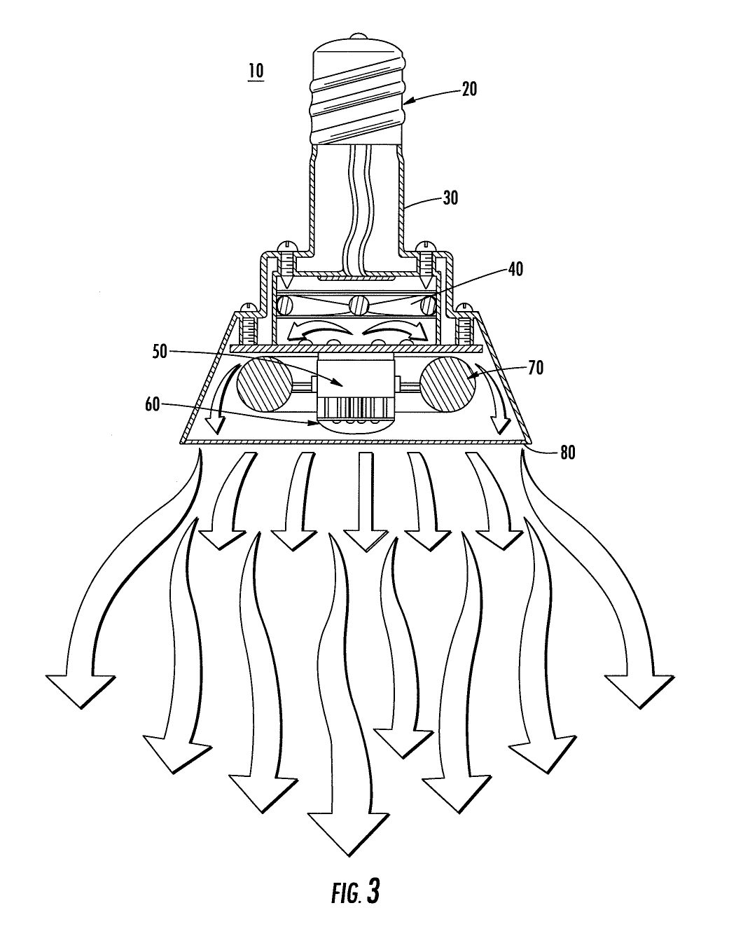

FIG. 3 is a cross-sectional view of the heat lamp 10 of FIG. 1. As shown in FIG. 3, the heat lamp 10 comprises a base 20, a housing 30, an air circulation device 40 such as a fan, a light-emitting diode (LED) driver with electronics 50 to regulate the power current for the LEDs and the heating source, a LED printed circuit board with LED 60, a heating element 70, and a safety screen or cover 80. In this view shown in FIG. 3, the heat lamp is shown in a vertical position with the base 20 of the heat lamp 10 positioned at the top and the safety screen or cover 80 positioned at the bottom such that the heat flow is directed downward. Also as shown in FIG. 3, the air circulation device 40 is positioned above the heating element 70 and the printed circuit board with LED 60.

In a preferred aspect of the present invention, the base 20 has a locking screw-in or socket base. An example of a socket base suitable for use in the present invention is an Edison base, also referred to as a medium base, or E26 base. Another non-limiting example is a GU 24 base.

The housing 30 of the heat lamp 10 is typically constructed of materials including, but not limited to, metals, ceramics, and polymers.

As shown in the figures, an air circulation device 40 such as a fan, piezo air movement device, bellows, a propeller, blade, or any other air circulation device is used to circulate air and direct heat flow. The heated forced air is directed towards, for example, a food product to ensure that the product is warmed to a specified temperature or a governmentally required food temperature.

The heat lamp 10 of the present invention comprises a light-emitting diode (LED) driver with electronics 50 such as control elements. Examples of control elements include, but are not limited to, heat controls, air movement controls, dimming controls or a combination thereof. Such controls provide the ability to set the temperature, light levels, and air flow to specified settings for temperature, light and speed, respectively, in order to maintain the product such as food in a safe condition yet emit the desired outputs.

The heat lamp 10 of the present invention comprises a light-emitting diode(s) (LED) 60 on a printed circuit board. Such LEDs and printed circuited boards are widely available in commerce from numerous suppliers in the lighting industry. The number and type of LEDs are typically selected in order to meet a specified light output.

In an aspect of the present invention, the heat lamp 10 comprises a light-emitting diode 60 of various colors such as white, red, or blue, among others. For example, the heat lamp 10 comprises a white light-emitting diode, a red light-emitting diode, or a combination thereof. The heat lamp of the present invention is suitable as a replacement for standard clear glass heat lamps and infrared red heat lamps.

In another aspect of the present invention, the red light-emitting diode or white light-emitting diode is combined with a heat lamp control or switch to provide the ability to select an appropriate color based on the desired end-use of the heat lamp. Furthermore, the heat lamp 10 optionally comprises a dimmable light emitting diode (LED) light module (not shown).

Although heat is dissipated off of the back of the LED as is typical of an LED, in the present invention, there is also heat generated from an external heat source which is generated by one or more heating elements. Thus, the heat lamp 10 of the present invention comprises a heating element 70 as shown in FIGS. 2 and 3. The heating element 70 has an optional adjustable control to adjust the amount of heat output to the desired levels. Examples of materials suitable for use in such heating elements include, but are not limited to, ceramics, quartz, tungsten, carbon, and a combination thereof. The heat that is generated from the LED 60 light source and the heating element 70 is forced downward with the adjustable external air circulation device 40 as shown in FIGS. 2 and 3.

The heat lamp 10 of the present invention comprises a safety cover or screen 80. The screen prevents accidental touching and burning from the heating element. The screen is made from numerous possible materials including, but not limited to, metals, ceramics, and polymeric materials.

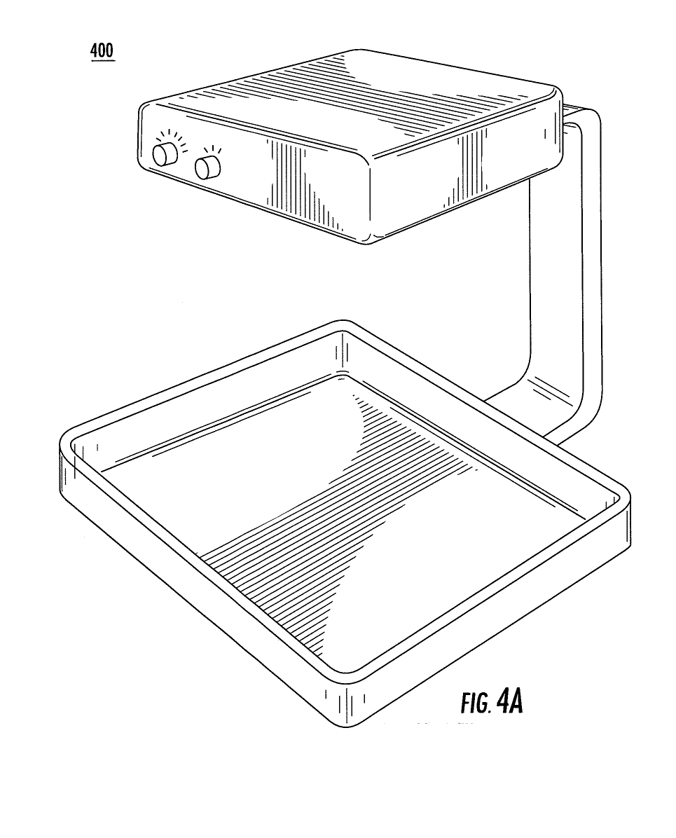

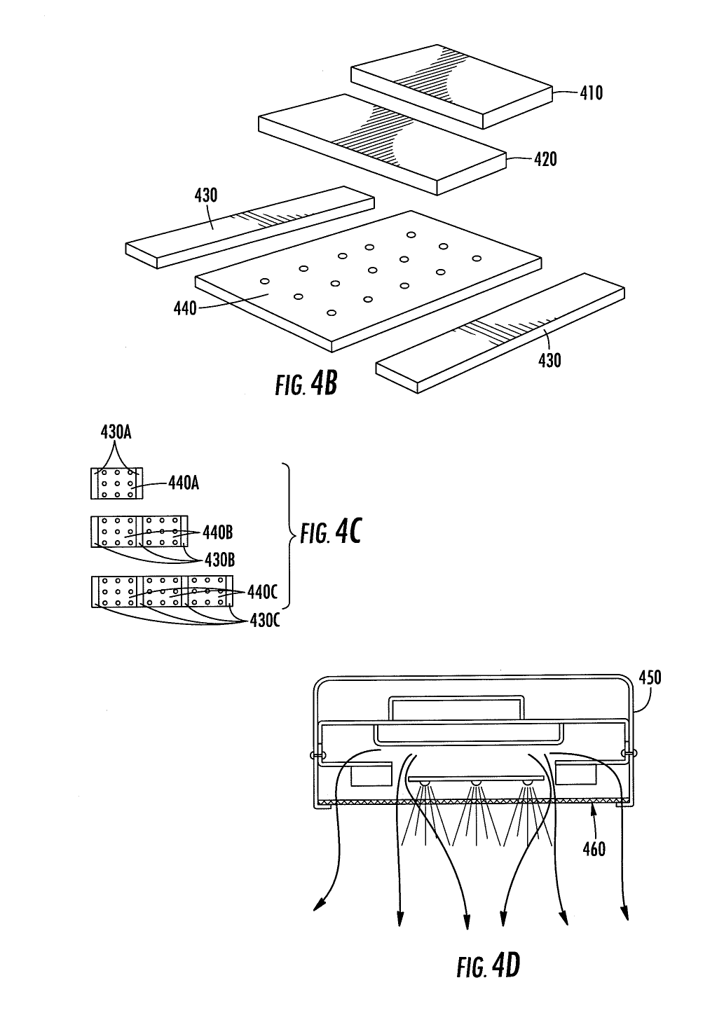

FIGS. 4A-4D relate to another aspect of the device of the present invention. FIG. 4A is a perspective view of a light and heat emitting device in accordance with an aspect of the present invention in a form of a module(s). FIG. 4B is an exploded view of the device of FIG. 4A. FIG. 4C is a close-up view of certain components of the device of FIG. 1 assembled in multiples. FIG. 4D is a cross-sectional view of the device of FIG. 4A.

Referring to FIG. 4A, the light and heat emitting device 400 in accordance of the present invention is shown in a form of a module(s). As shown in FIGS. 4B-4D, the heat and light emitting device 400 comprises a housing 450. The housing 450 comprises a light-emitting diode on a printed circuit board 440 having one or more edges, a heating element 430, an air circulation device 420, and an electronic driver 410 for regulating power to the air circulation device 420 and the light-emitting diodes of the printed circuit board 440. The device 400 further comprises a screen or cover 460 for attachment to the housing 450. As shown in FIG. 4D, the heat and light emitting device 400 is in a form of a square or rectangular shaped module.

As shown in the FIGS. 4B-4D, the heating element 430 is adjacent to one or more edges of the printed circuit board 440. Also as shown in FIG. 4C one or more heating elements (430A, 430B, and 430C) and printed circuit boards (440A, 440B, 440C) are optionally laid edge to edge. Preferably, there is a heating element adjacent two opposing edges of the printed circuit board.

Also as shown in FIGS. 4B and 4D, the electronic driver 410 is positioned above the air circulation device 420. The air circulation device 420 is also shown positioned above the printed circuit board 440 and the heating element(s) 430. Preferably, the heating element and printed circuit board are in the same plane.

In another aspect of the present invention, the heat and light emitting device of the present invention is coated or uncoated. If coated, the coating is optionally on the internal or external surfaces of the heat and lighting device as well as on one or more of the components housed within the device. If uncoated, the heat lamp configuration is suitable as a replacement for conventional incandescent heat lamp bulbs in bathrooms or other applications where uncoated heat lamps are used. If coated, the device minimizes deterioration due to harsh environments such as wash down areas and areas of high moisture. In a preferred aspect of the present invention, the coating has a thickness in a range of about 1 mil to about 20 mils.

Examples of suitable coating materials include, but are not limited to, conformable coatings such as silicone, epoxy, urethane, acrylate, perfluoroalkoxy, or a combination thereof. In a preferred aspect of the present invention, the coating comprises silicone. In another preferred aspect of the present invention, the silicone coating comprises at least 60 weight percent (wt %) of a silicone elastomer, preferably at least 99 wt % of a silicone elastomer. Another suitable silicone coating for use in the present invention further comprises from 0 to 40 wt % of diisopropoxy di(ethoxyacetoacetyl) titanate, alkoxysilane reaction product, methyl alcohol, or a combination thereof.

Various methods can be employed for coating the heat and light emitting device in accordance with the present invention. One such method of the present invention comprises applying a coating to an exposed surface of the heat and light emitting device by dipping an exposed surface or other surface to be coated into a vat. Once the device is populated, it is placed on the dipping machine. The machine, using computer-implemented process control systems, dips the heat and light emitting device to a given height at a given rate. The device is then raised out of the vat at a given rate to ensure that the thickness is controlled. The device then travels by belt to a pre-cure oven to begin the heating process. If desired, the device is flipped back and forth to control sagging or running of the coating. After pre-curing, the device is then transported by belt to the main curing oven. In this oven the final curing is completed. This is achieved by controlling the speed of the belt as well as the oven temperatures. A cure time and temperature is selected in order to control the adhesion of the coating to the device. This is typically accomplished at 350° F. for 15 to 30 minutes depending upon the shape and weight of the heat and light emitting device or component thereof. Based upon the size, shape and weight, the typical production speeds may vary between 90 and 450 parts per hour.

As stated above, it is desired that the method is automated and computer controlled. The method comprises controlling the entry rate of the heat and light emitting device or component thereof into the vat. An advantage of controlling the entry rate of the device into the vat is in order to minimize bubbling. The method further comprises controlling the exit rate of the heat and light emitting device into the vat. An advantage of controlling the exit rate is to minimize thickness variation in the coating. The method further comprises controlling the cure rate and the time to cure in the ovens in order to minimize variation in the coating.

Dipping is advantageous as compared to other coating methods such as spraying. In accordance with the present invention, the coating is applied in order to provide the maximum protection against environmental conditions such as moisture, humidity, heat, and exposure in wash down areas. A typical spray system does not provide a thick enough coating to provide the required thickness necessary for adequate environmental protection.

For coating purposes, coating is optionally present on or applied to an internal or external surface(s) of the device as well as components thereof, including but not limited to, the housing, screen, LEDs, and supporting electronics. It is particularly desirable that the coating composition or material applied to the heat and light emitting device is shatterproof. Examples of suitable coating materials include, but are not limited to, silicone, epoxy, urethane, acrylate, perfluoroalkoxy (PFA) or other compounds employing one or more of these materials. Preferably, the silicone is in a form of a room temperature vulcanizing (RTV) silicone, a moisture cured silicone, or a heat cured silicone.

The thickness of the coating often varies between about 1 mil to about 20 mils depending upon the shape, size and weight of the heat and light emitting device. The device of the present invention is particularly desirable for use in end use applications including, but not limited to, food warming areas in the food service industry, brooding or any application that may require a heat source to maintain a specific heat. For example, it can be used to maintain the proper temperature of foods in areas including, but not limited to, food warming trays, buffets, hotels, and in fast food restaurants. Other applications include, but are not limited to, warming of broods for poultry or any process where heat is required to maintain a specific temperature.

Among the advantages of the heat and light emitting device in a form of a heat lamp in accordance with aspects of the present invention is that it is expected to provide up to 75% in energy savings and last up to six times longer than conventional heat lamps. In a preferred aspect of the present invention, the heat and light emitting device has a wattage in a range of about 75 to 500 Watts. The device also minimizes the potential for burns that the user is exposed to with current technology due to the heat on the surface face of a conventional heat lamp. In the present invention, the heat is transferred away from the face to the back of the lamp thus preventing burns from occurring. Additionally, current technology allows for hot frying grease to reach the conventional heat lamp causing it to explode. The heat and light emitting device of the present invention also eliminates this problem.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. A heat and light emitting device comprising:
a base,
a housing for attachment to the base, the housing comprising an air circulation device, a light-emitting diode, and a heating element, and
a cover for attachment to the housing,
wherein the heat and light emitting device is in a form of a heat lamp.

2. The device according to claim 1, wherein the heating element comprises a material selected from the group consisting of ceramics, quartz, tungsten, carbon, and a combination thereof.

3. The device according to claim 1, wherein the heat lamp has a wattage in a range of about 75 to 500 Watts.

4. The device according to claim 1, wherein any surface or component of the heat lamp is coated.

5. The device according to claim 1, wherein the light-emitting diode is coated.

6. The device according to claim 5, wherein the coating is shatterproof.

7. The device according to claim 5, wherein the coating comprises a silicone, epoxy, urethane, acrylate, perfluoroalkoxy, or a combination thereof.

8. The device according to claim 7, wherein the silicone is in a form of a room temperature vulcanizing silicone, a moisture cured silicone, or a heat cured silicone.

9. The device according to claim 7, wherein the silicone comprises at least 60 weight percent (wt %) of the coating.

10. The device according to claim 1, wherein the heat lamp is in a shape of a BR40 heat lamp.

11. The device according to claim 1, wherein the base is an E26 or GU 24 base.

12. The device according to claim 1, wherein the air circulation device is a fan, piezo air movement device, bellows, propeller, blade or any other air movement device.

13. The device according to claim 1, further comprising a control element.

14. The device according to claim 13, wherein the control element is for heat control, air movement control, dimming control, color control, or a combination thereof.

15. The device according to claim 5, wherein the coating has a thickness in a range of about 1 mil to about 20 mils.

16. A heat and light emitting device comprising:
a housing comprising a light-emitting diode on a printed circuit board having one or more edges, a heating element, an air circulation device, and an electronic driver for regulating power to the air circulation device and the light-emitting diode, and
a cover for attachment to the housing,
wherein the heat and light emitting device is in a form of a square, rectangular or other geometric shaped module.

17. The device according to claim 16, wherein the heating element is adjacent to one or more edges of the printed circuit board.

18. The device according to claim 17, wherein one or more heating elements and printed circuit boards are laid edge to edge.

19. The device according to claim 16, wherein the electronic driver is positioned above the air circulation device.

20. The device according to claim 16, wherein the air movement device is positioned above the printed circuit board.

21. The device according to claim 16, wherein the heating element and printed circuit board are in the same plane.

22. The device according to claim 16, wherein the heating element comprises a material selected from the group consisting of ceramics, quartz, tungsten, carbon, and a combination thereof.

23. The device according to claim 16, wherein the device has a wattage in a range of about 75 to 500 Watts.

24. The device according to claim 16, wherein any surface or component of the device is coated.

25. The device according to claim 16, wherein the light-emitting diode is coated.

26. The device according to claim 25, wherein the coating is shatterproof.

27. The device according to claim 25, wherein the coating comprises a silicone, epoxy, urethane, acrylate, perfluoroalkoxy, or a combination thereof.

28. The device according to claim 27, wherein the silicone is in a form of a room temperature vulcanizing silicone, a moisture cured silicone, or a heat cured silicone.

29. The device according to claim 27, wherein the silicone comprises at least 60 weight percent (wt %) of the coating.

30. The device according to claim 16, wherein the air circulation device is a fan, piezo air movement device, bellows, propeller, blade or any other air movement device.

31. The device according to claim 16, further comprising a control element.

32. The device according to claim 31, wherein the control element is for heat control, air movement control, dimming control, color control, or a combination thereof.

33. The device according to claim 25, wherein the coating has a thickness in a range of about 1 mil to about 20 mils.

34. A method of making a heat and light-emitting device, the method comprising:
providing a base,
attaching a housing to the base, the housing comprising an air circulation device, a light-emitting diode, and a heating element, and
attaching a cover to the housing to form the device.

35. The method according to claim 34, wherein the heating element comprises a material selected from the group consisting of ceramics, quartz, tungsten, carbon, and a combination thereof.

36. The method according to claim 34, wherein the device has a wattage in a range of about 75 to 500 Watts.

37. The method according to claim 34, further comprising applying a coating to a surface or a component of the device.

38. The method according to claim 37, wherein application of the coating occurs by dipping a surface or component of the device lamp in a coating composition.

39. The method according to claim 37, wherein the coating comprises a silicone, epoxy, urethane, acrylate, perfluoroalkoxy, or a combination thereof.

40. The method according to claim 39, wherein the silicone is in a form of a room temperature vulcanizing silicone, a moisture cured silicone, or a heat cured silicone.

41. The method according to claim 37, wherein the coating has a thickness in a range of about 1 mil to about 20 mils.

42. The method according to claim 37, further comprising curing the coating.
